(19) United States
(12) Patent Application Publication
(10) Pub. No.: US 2021/0242480 A1
(43) Pub. Date: Aug. 5, 2021

(54) PLATINUM-COATED POLYIMIDE PARTICLES AND ARTICLES THEREOF

(71) Applicant: 3M INNOVATIVE PROPERTIES COMPANY, St. Paul, MN (US)

(72) Inventors: Jiyoung Park, Woodbury, MN (US); Cedric Bedoya, Woodbury, MN (US); Moses M. David, Wells, TX (US); Krzysztof A. Lewinski, Mahtomedi, MN (US)

(21) Appl. No.: 17/049,751

(22) PCT Filed: Apr. 29, 2019
(86) PCT No.: PCT/US2019/029557

§ 371 Date: Oct. 22, 2020

Related U.S. Application Data
(60) Provisional application No. 62/665,001, filed on May 1, 2018.

(51) Int. Cl. H01M 8/1051; C25B 1/04; H01M 8/1044; C25B 9/23; C25B 13/08; H01M 8/1053

(52) U.S. Cl. CPC H01M 8/1051; C25B 1/04; H01M 8/1044; H01M 2008/1095; C25B 13/08; H01M 8/1053; C25B 9/23

(57) ABSTRACT

Described herein is a composition comprising: a plurality of particles, wherein the particles comprise a polyimide core; and a coating thereon, wherein the coating comprises at least one of a metallic platinum and a platinum oxide. Such compositions may be used as a polymer electrolyte membrane for electrochemical cells, including fuel cells or water electrolyzers.

### TECHNICAL FIELD

Platinum-coated polyimide particles are discussed. Such particles may be used in polymer electrolyte membranes for electrochemical cells including water electrolyzers and fuel cells.

### SUMMARY

There is a desire to develop thinner polymer electrolyte membranes that have good mechanical properties. In electrolyzers, there is a desire for the polymer electrolyte membrane to mitigate crossover of hydrogen to the anode. In fuel cells, there is a desire for the polymer electrolyte membrane to be humidified to decrease the membrane's resistance to proton conduction.

In one aspect, a composition is disclosed, the composition comprising: a plurality of particles, wherein the particles comprise a polyimide core; and a coating thereon, wherein the coating comprises metallic platinum and/or platinum oxide.

In one aspect, a polymer electrolyte membrane is disclosed, the polymer electrolyte membrane comprising: (a) a plurality of particles, wherein the particles comprise a polyimide core; and a coating thereon, wherein the coating comprises metallic platinum and/or platinum oxide; and (b) an ion-conducting polymer, wherein the plurality of particles is dispersed within the ion-conducting polymer.

In one aspect, a water electrolyzer is disclosed, the water electrolyzer comprising a polymer electrolyte membrane, wherein the polymer electrolyte membrane comprises: (a) a plurality of particles, wherein the particles comprise a polyimide core; and a coating thereon, wherein the coating comprises metallic platinum and/or platinum oxide; and (b) an ion-conducting polymer, wherein the plurality of particles is dispersed within the ion-conducting polymer.

In one aspect, a fuel cell is disclosed, the fuel cell comprising a polymer electrolyte membrane, wherein the polymer electrolyte membrane comprises: (a) a plurality of particles, wherein the particles comprise a polyimide core; and a coating thereon, wherein the coating comprises metallic platinum and/or platinum oxide; and (b) an ion-conducting polymer, wherein the plurality of particles is dispersed within the ion-conducting polymer.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a schematic illustration of a polymer electrolyte membrane of one embodiment of the present disclosure;

FIG. 2 is a schematic illustration of a polymer electrolyte membrane of one embodiment of the present disclosure;

FIG. 3 is a schematic illustration of a polymer electrolyte membrane of one embodiment of the present disclosure;

FIG. 4 is a schematic illustration of a polymer electrolyte membrane of one embodiment of the present disclosure;

FIG. 5 is a schematic of an exemplary water electrolyzer described herein; and

FIG. 6 is a schematic of an exemplary fuel cell described herein.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B);

“backbone” refers to the main continuous chain of the polymer;

“monomeric unit” is a divalent group of atoms which are derived from a monomer and form part of the essential repeating structure of a polymer;

“perfluorinated” means a group or a compound derived from a hydrocarbon wherein all hydrogen atoms have been replaced by fluorine atoms. A perfluorinated compound may however still contain other atoms than fluorine and carbon atoms, like oxygen atoms, chlorine atoms, bromine atoms and iodine atoms; and

“polymer” refers to a macrostructure having a number average molecular weight (Mn) of at least 50,000 dalton, at least 100,000 dalton, at least 300,000 dalton, at least 500,000 dalton, at least, 750,000 dalton, at least 1,000,000 dalton, or even at least 1,500,000 dalton and not such a high molecular weight as to cause premature gelling of the polymer.

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself; element B by itself; element C by itself; A and B; A and C; B and C; and a combination of all three.

Electrochemical cells are devices that either generate electrical energy from chemical reactions or facilitate chemical reactions through the use of electrical energy. Electrochemical cells that involve hydrogen can be divided into two distinct classes: fuel cells, which convert hydrogen fuel and oxygen into water with the generation of usable electricity; and water electrolyzers, which use electricity to split water into hydrogen and oxygen, generating ultra-pure hydrogen.

Disclosed herein is a polymer electrolyte membrane (PEM) which can be used in electrochemical cells that has improved mechanical and performance properties for both fuel cell and water electrolyzer applications. The PEMs disclosed herein comprise platinum-coated particles that are dispersed in an ion-conducting polymer.

Platinum-Coated Particles

The particles disclosed herein are platinum-coated polyimide particles. As used herein “platinum” in the phrase “platinum-coated” refers to metallic platinum and/or platinum oxide.

The core of the particles comprises a polyimide polymer. Such polymers comprise a polyimide monomeric unit,

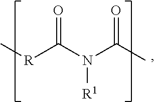

where R, and R¹ are independently selected from a carbon-containing group (R being a divalent group and R¹ being a monovalent group). In one embodiment, the backbone of the polyimide comprises aromatic groups. In another embodiment, the backbone of the polyimide is aliphatic and does not comprise aromatic groups.

Polyimide polymers are known in the art and can include, for example, poly(bisphenol A anhydride-co-1,3-phenylenediamine); a copolymer derived from 3,3′,4,4′-biphenyltetracarboxylic dianhydride and phenylenediamine; or a copolymer derived from benzophenone 3,3′,4,4′-tetracarboxylic acid dianhydride and a mixture of di(4-aminophenyl) methane and toluene diamine or the corresponding diisocyanates, 4,4′-methylenebis(phenyl isocyanate) and toluene diisocyanate. In one embodiment, the polyimide polymers may include those as disclosed in U.S. Pat. No. 7,812,099 (Rogl et al.), herein incorporated by reference.

In one embodiment, the polyimide comprises the following monomeric units:

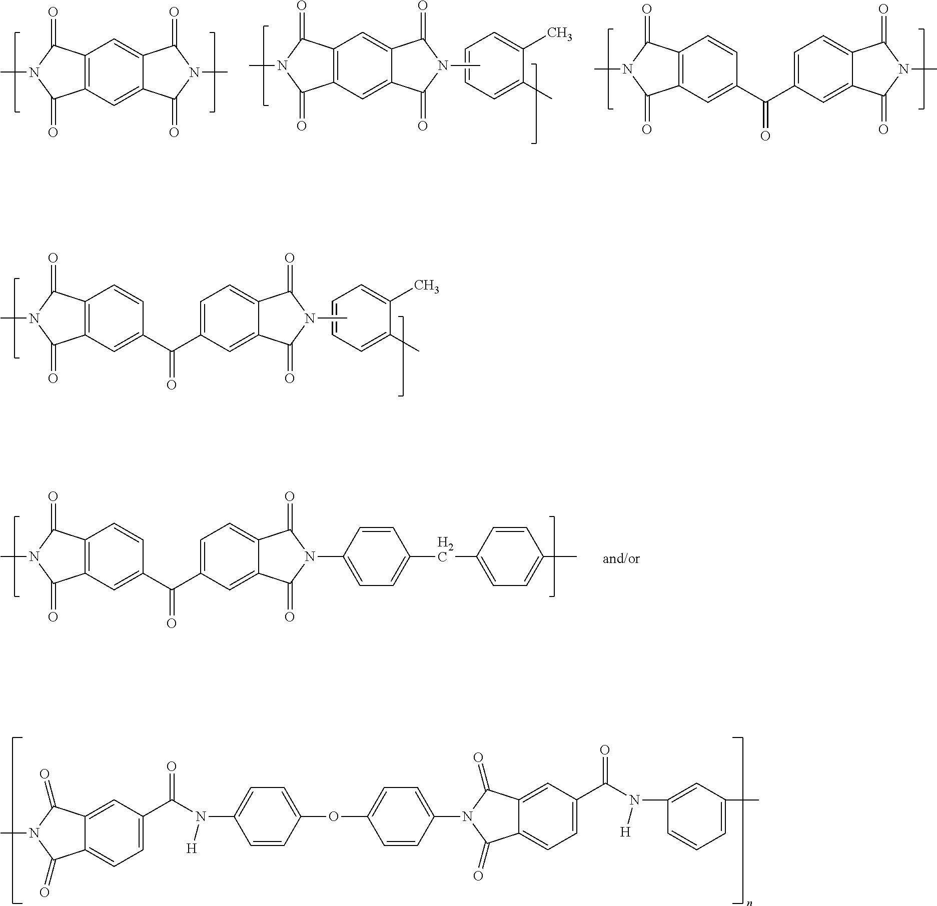

wherein, as used in the art, the line between the nitrogen and the toluene ring above indicates that the bond is located at any carbon vertex on the ring so long as the valency of the carbon is satisfied.

Commercially available polyimides include: poly-oxydiphenylenen-pyromellitimide such as that available under the trade designations “KAPTON” and “VESPEL” by E.I duPont de Nemours and Co., Wilmington, Del.; polyimides under the trade designation “PLAVIS” provided by Daelim H&L; polyimides available under the trade designation “MELDIN” from Saint-Gobain, Malvern, Pa.; polyamide-imides available under the trade designation “TORLON” from Solvay S.A., Brussels, Belgium; and polyimide particles available under the trade designation “POLYIMIDE P84 NT” such as “POLYIMIDE P84 NT2” and “POLYIMIDE P84 NT1” available from Evonik Industries, Essen, Germany.

In one embodiment, the polyimide core is solid (i.e., does not comprise a bubble of gas or air) and has an average diameter of at least 500 nanometer (nm), 1 mm (millimeter), or even 2 mm; and less than 5 mm, 7 mm, or even 10 mm.

In one embodiment, the polyimide core is substantially spherical, which means that when magnified into a two-dimensional image, the image appears at least substantially circular. A particle will be considered substantially spherical if its outline fits within the intervening space between two, concentric, truly circular outlines differing in diameter from one another by up to about 10% of the diameter of the larger of these outlines.

The polyimide core is coated with a platinum-containing coating. The coating comprises metallic platinum and/or platinum oxide. Other metals may be present such as metallic iridium, metallic ruthenium, iridium oxide, ruthenium oxide, or combinations thereof. In one embodiment, the platinum-containing coating is “not organic”, meaning that the platinum-containing coating does not comprise a C—H or C—F bond. In one embodiment, the platinum-containing coating consists essentially of metallic platinum and/or platinum oxide, for example, comprising at least 95, 98, 99, or even 100% by weight of metallic platinum or platinum oxide.

In one embodiment, the platinum-containing coating composition is disposed directly onto the polyimide core. In other words, there is no layer (e.g., a tie layer) located between the surface of the polyimide core and the platinum-containing coating.

The platinum-containing coating may be continuous or discontinuous across the surface of the polyimide core. In one embodiment, the continuous coating is at least one monolayer thick and has an average thickness of less than 25, 20, 15, 10, or even 5 nm. In one embodiment, the platinum-containing coating is discontinuous comprising discrete regions or “islands” of coating. In one embodiment, the regions of platinum-containing coating in the discontinuous coating are at least one monolayer thick and the regions have an average thickness of less than 10, 5, or even 1 nm. In one embodiment, the discrete regions of platinum-containing coating have an average diameter of at least 1, 2, or even 3 nm; and no more than 5, 8, or even 10 nm.

The platinum-containing coating may be deposited onto the polyimide cores by using techniques such as chemical vapor deposition, atomic layer deposition, sputter coating, evaporation, and liquid coating. Such techniques are known in the art. In one embodiment, platinum is deposited using dimethyl(1, 5-cyclooctadiene) platinum (II) as a precursor onto the polyimide cores using chemical vapor deposition in an reduced environment (e.g., hydrogen gas), at low pressure (e.g., from 0.1 to 100 Torr) and at elevated temperature (e.g., from 150 to 350° C.).

In one embodiment, the platinum-coated particles have an average diameter of at least 500 nanometer (nm), 1 mm (millimeter), or even 2 mm; and less than 5 mm, 7 mm, or even 10 mm. In one embodiment, the platinum-coated particles are substantially spherical as defined above.

In one embodiment, the platinum-coated particles comprise at least 0.10, 0.15, or even 1.0% by weight as measured by metallic platinum; and at most 20, 30, 40, 50, 60, 70, 80, 90, 95, 99.0, or even 99.5% by weight as measured by metallic platinum.

Polymer Electrolyte Membrane

In one embodiment, the platinum-coated particles are dispersed within an ion-conductive polymer to form a layer that can be used as a polymer electrolyte membrane.

Exemplary ion-conductive polymer typically bear anionic functional groups bound to a common backbone, which are typically sulfonic acid groups, but may also include carboxylic acid groups, imide groups, imide acid groups, amide groups, or other acidic functional groups. Anion-conducting membranes comprising cationic functional groups bound to a common backbone are also possible, but are less commonly used.

In one embodiment, the ion-conductive polymer has a group represented by a formula —R_{f}SO₂Y as a side group, where R_{f} is a branched or non-branched perfluoroalkyl group, perfluoroalkoxy group or perfluoroether group including from 1 to 15 carbon atoms and from 0 to 4 oxygen atoms; and Y is a —OH, —NHSO₂—R_{f}^{″}, —NHSO₂—R_{f}^{′}—SO₃H, —NHSO₂—R_{f}^{′}—SO₂—NH—SO₂—R, where R_{f}^{″} is a perfluorinated alkyl group, optionally comprising at least one ether linkage, wherein R_{f}^{″} comprises 1 to 15, 1 to 10, 1 to 6, or even 2 to 6 carbon atoms; R_{f}^{′} is a perfluorinated alkylene group, optionally comprising at least one ether linkage, wherein R_{f}^{′} comprises 1 to 15, 1 to 10, 1 to 6, or even 2 to 6 carbon atoms; and R is a perfluorinated alkyl group, a partially fluorinated alkyl group, or a nonfluorinated alkyl or aryl group, optionally comprising at least one ether linkage, wherein R_{f}^{″} comprises 1 to 15, 1 to 10, 1 to 6, or even 2 to 6 carbon atoms. From the viewpoint of achieving greater proton transport ability, in one embodiment, the ion-conductive polymer has a group represented by —OCF₂CF(CF₃)OCF₂CF₂SO₂Y, —O(CF₂)₄SO₂Y, —O(CF₂)₂SO₂Y, or combinations thereof, where Y is defined above.

In a preferred aspect, the main chain of the ion-conductive polymer is a fluorocarbon chain that is partially fluorinated or completely fluorinated. The suitable concentration of fluorine in the main chain may be not less than approximately 40 mass % based on the total mass of the main chain. In a preferred aspect, a main chain of the fluoropolymer is a perfluorocarbon chain.

In one embodiment, exemplary ion-conductive polymers include perfluorosulfonic acid or perfluorosulfonimide acid and salts thereof.

Typical ion-conductive polymers include those available from DuPont Chemicals, Wilmington, Del., under the trade designation “NAFION;” Solvay, Brussels, Belgium, under the trade designation “AQUIVION;” and from Asahi Glass Co. Ltd., Tokyo, Japan, under the trade designation “FLEMION.” The polymer electrolyte may be a copolymer of tetrafluoroethylene (TFE) and FSO₂—CF₂CF₂CF₂CF₂—O—CF═CF₂, described in U.S. Pat. No. 6,624,328 (Guerra) and U.S. Pat. No. 7,348,088 (Hamrock et al.), and U.S. Pub. No. 2004/0116742 (Guerra), the disclosures of which are incorporated herein by reference.

In one embodiment, the ion-conductive polymer has an equivalent weight (EW) up to 1500 (in some embodiments, up to 1200, 1100, 1000, 900, 825, 800, 725, or even up to 625), and more than 500 EW, where equivalent weight refers to the mass of the ion-conductive polymer in grams per one equivalent ion-conductive group.

In one embodiment, the weight % of the platinum-coated polyimide particles to the ion-conductive polymer is at least 0.05, 0.5, 1, 5, or even 10%: and no more than 20, 30, 40, or even 50%. The platinum-coated polyimide particles are dispersed within the ion-conductive polymer.

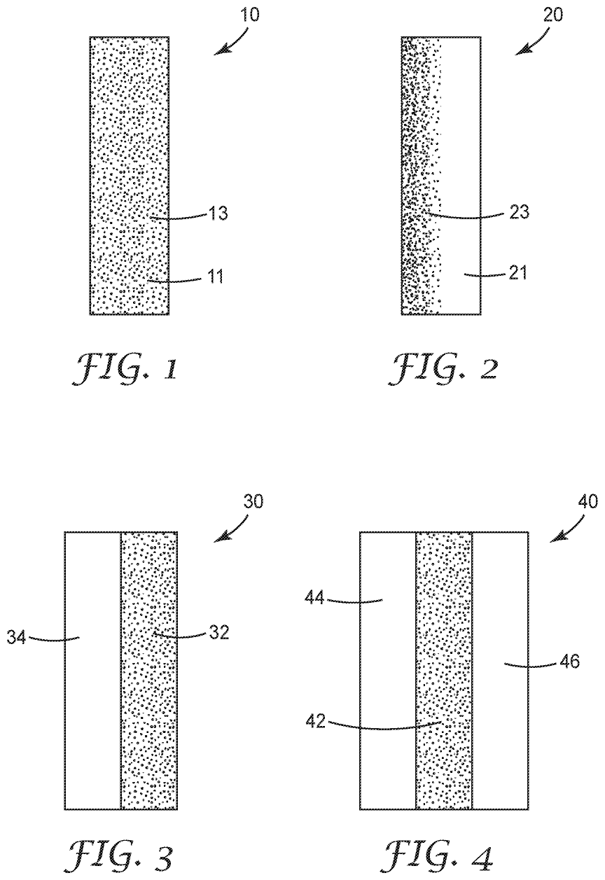

In one embodiment, the platinum-coated polyimide particles are dispersed homogeneously throughout a single layer as shown in polymer electrolyte membrane 10 of FIG. 1, wherein platinum-coated polyimide particles 13 are dispersed within ion-conductive polymer 11.

In another embodiment, the platinum-coated polyimide particles are not homogeneously dispersed throughout the layer. For example, in one embodiment, there is a higher concentration of platinum-coated polyimide particles in one region of the layer. In one embodiment, there may exist a concentration gradient, which is continuous or discontinuous as one traverses through the layer parallel to the flow of ions during use. Such an unhomogeneous dispersion within ion-conductive polymer 21 is shown in FIG. 2, wherein platinum-coated polyimide particles 23 are more concentrated on the left side of polymer electrolyte membrane 20 than on the right side.

These PEMs comprising the platinum-coated polyimide particles may be made by any suitable method. For example, a mixture containing the platinum-coated polyimide particles and the ion-conducting polymer may be cast from a suspension. Any suitable casting method may be used, including bar coating, spray coating, slit coating, and brush coating. Alternately, the PEM may be formed from a melt process such as extrusion. After forming, the PEM may be annealed, typically at a temperature of at least 120° C. (in some embodiments, at least 130° C., 150° C., or higher).

As known in the art, the layer comprising the platinum-coated polyimide particles dispersed within an ion-conductive polymer as described above can be laminated or combined with other ion-conductive polymer sheets to form a PEM. As shown in FIG. 3, ion-conductive membrane 30 comprises layer 32, which is a layer comprising platinum-coated polyimide particles dispersed within an ion-conductive polymer, which is disposed on a first major surface of layer 34, which is a layer comprising an ion-conductive polymer. As shown in FIG. 4, ion-conductive membrane 40 comprises layer 42, which is a layer comprising platinum-coated polyimide particles dispersed within an ion-conductive polymer, which is disposed between layers 44 and 46, which are both layers comprising an ion-conductive polymer. The additional ion-conductive polymer layers (i.e., the layer not comprising the platinum-coated polyimide particles) described above may comprise, in addition to the ion-conductive polymer, polyimide particles that are not platinum coated, and/or a salt or oxide of manganese or cerium.

In one embodiment, the PEM disclosed herein, further comprises a continuous porous mechanical support. Such a continuous mechanical support may include a woven material, a non-woven material (e.g., an electrospun web), or a perforated sheet which a positioned parallel to the electrodes of the electrochemical cell when in use to provide strength to the ion-conductive polymer and prevent sag while allowing transport of ions. It is preferable that the continuous mechanical support be a non-ion-conductive polymer, such as polytetrafluoroethylene, polyvinylidene fluoride (PVDF) and polyvinylidene fluoride copolymer, and hydrocarbon aromatic polymer as a non-fluorinated material, such as polyphenylene oxide (PPO), polyphenylene ether sulfone (PPES), polysulfone (PSU), poly ether sulfone (PES), poly ether ketone (PEK), polyether ether ketone (PEEK), polyether imide (PEI), polybenzimidazole (PBI), polybenzimidazole oxide (PBIO), polyphenyl ether (PPE), and a blended material thereof. In the present disclosure, the continuous mechanical support may be present in any layer of the polymer electrolyte membrane, for example, layer 42, 44, or 46 of FIG. 4.

Because these constructions (layer comprising the platinum-coated polyimide particles dispersed within an ion-conductive polymer and optional additional layers) are used as PEMs, the PEMs are non-electronically conducting, which means that the PEM has an area specific resistance of at least 10, 100, or even 1000 Ohm·cm². For example, in a single-layer PEM comprising the platinum-coated polyimide particles in an ion-conducting polymer, the concentration of platinum-coated polyimide particles is held below a certain level so as to not conduct electronic current from one electrode to another. In the instance of a multilayer PEM, having a first layer comprising platinum-coated polyimide particles in an ion-conducting polymer sandwiched between two ion-conductive polymer layers, the concentration of platinum-coated polyimide particles in the first layer may be high, however because it is sandwiched between two ion-conductive polymer layers that do not have platinum-coated polyimide particles, the PEM construction would not conduct electronic current from one electrode to another.

In one embodiment, the polymer electrolyte membrane is dense and substantially pore-free. The density of a dense, substantially pore-free polymer electrolyte membrane of the present disclosure can be calculated using the following equation,

$${ρ}_{MEMBRANE} = \frac{\sum {l}_{n}}{\sum ( \frac{{l}_{n}}{{ρ}_{n}} )}$$

Where n is the number of constituents in the polymer electrolyte membrane, lₙ is the areal loadings (or basis weights) of the constituents, and ρₙ is the bulk densities of the constituent elements. For example, the density of a dense, substantially pore-free composite membrane containing ionomer with an areal loading of 0.02 g per cm², containing Pt with an areal loading of 0.0001 g of per cm², and containing polyimide with an areal loading of 0.005 g per cm², is calculated to have a density of 1.55 g/cm², based on the bulk densities of ionomer, Pt, and polyimide, 1.58, 21.45, and 1.42 g/cm³, respectively.

In some embodiments, the polymer electrolyte membrane of the present disclosure may comprise a small number of voids or pores. Voids and pores, if present, are undesirable features of the PEM, as they may alloy gaseous products to be more readily transported from one side of the membrane to the other than if the voids and pores were not present. Voids and pores may be unintentionally incorporated into the PEM during membrane fabrication. If the PEM is substantially free from moisture, the pores or voids will primarily consist of pockets of a gas, such as air, which generally will have a much lower density than the typical constituent elements of the PEM such as ionomer, Pt, and polyimide. The density of air at 15° C. and at sea level is 1.23×10⁻³ g/cm³. A substantially moisture-free membrane which contains pores may have a lower density than a substantially moisture-free membrane which does not contain pores. The presence of voids or pores may be detected by determining the density of a substantially moisture-free membrane by dividing the measured areal mass by the measured thickness, and comparing this measured density to the calculated density of a dense, substantially pore-free PEM. In some embodiments, the density of the substantially moisture-free PEM of the present disclosure is at least 90%, 95%, 96%, 97%, 98% or even 99% of the density of a dense, substantially pore-free PEM.

In one embodiment, the PEM is substantially free of any Ce or Mn (i.e., no greater than 0.001 mg/cm³ of either Ce or Mn, calculated as elemental Ce and Mn, respectively).

Optionally, the PEM is washed in acid (e.g., 1.0 molar nitric acid to remove any metal cation impurities, or nitric acid plus hydrogen peroxide to remove metal cation impurities and organic impurities, followed by rinsing in deionized water) prior to deposition or lamination of catalyst (including catalyst-bearing nanostructured whiskers) to remove cation impurities. Heating the washing bath (e.g., to 30° C., 40° C., 50° C., 60° C., 70° C., or even 80° C.) may make the cleaning faster. Benefits of acid washing the membrane may depend on the particular membrane.

In some embodiments, the membrane has a thickness of at least 1, 5, or even 10 micrometers and at most 100, 150, 200, 150, 400, 500, 750, or even 1000 micrometers.

The PEMs disclosed herein may be used in electrochemical cells. Such cells are used to generate power (e.g., fuel cell) or convert power into gas (e.g., water electrolyzer).

Water Electrolyzers

PEM based water electrolyzers produce hydrogen at the cathode via a hydrogen evolution reaction (HER) and oxygen at the anode via an oxygen evolution reaction (OER). The designation of the electrodes as anode or cathode in an electrochemical device follows the IUPAC convention that the anode is the electrode at which the predominant reaction is oxidation (e.g., the H₂ oxidation electrode for a fuel cell, or the water oxidation/O₂ evolution reaction electrode for a water or CO₂ electrolyzer). Higher operating pressures on the water electrolyzer cathode (e.g., even approaching 50 bar) create a situation known in the field as hydrogen crossover, where the hydrogen gas (H₂) crosses from the cathode where it is produced through the PEM, back to the anode. This situation creates both an efficiency loss and in some situations an undesired amount of H₂ mixing with the anode gas (O₂) (e.g., exceeds 4 vol. %, which is about the lower explosive limit (LEL)). In the present disclosure, it has been discovered that the use of the platinum-coated polyimide particles in the PEM can mitigate this crossover of hydrogen to the anode, while allowing thin polymer electrolyte membranes.

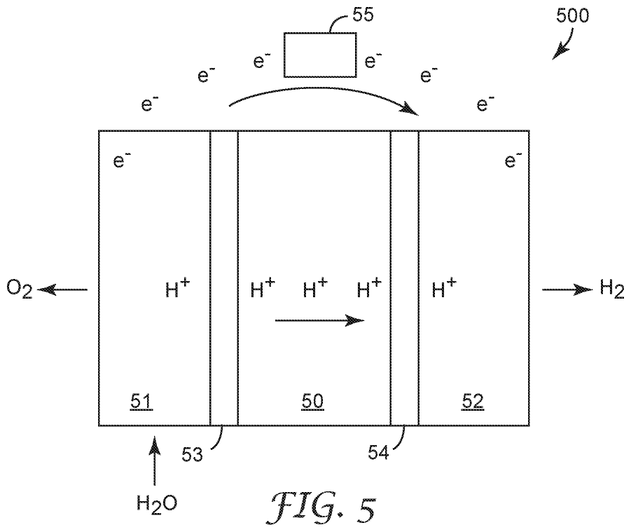

Shown in FIG. 5, is exemplary water electrolyzer cell 500 comprising PEM 50, cathode 54, and anode 53. In some embodiments, cathode 54 comprises a first catalyst of metallic Pt and/or Pt oxide. Anode 53 has second catalyst comprising metallic Ir and/or Ir oxide. As shown, cell 500 also includes optional first fluid transport layer (FTL) 51 adjacent anode 53, and optional second fluid transport layer 52 situated adjacent cathode 54. FTLs 51 and 52 can be referred to as diffuser/current collectors (DCCs) or gas diffusion layers (GDLs). In operation, water is introduced into the anode portion of cell 500, passing through first fluid transport layer 51 and over anode 53. Power source 55 applies an electrical current source on cell 500.

Membrane 50 is a PEM that preferentially permits hydrogen ions (solvated protons) to pass through the membrane to the cathode portion of the cell, thus conducting an electrical current through the membrane. The electrons cannot normally pass through the membrane and, instead, flow through an external electrical circuit in the form of electrical current. The hydrogen ions (H) combine with the electrons at cathode 54 to form hydrogen gas, and the hydrogen gas is collected through second fluid transport layer 52 situated adjacent cathode 54. Oxygen gas is collected at the anode of cell 500 via first fluid transport layer 51 situated adjacent anode 53.

Gas diffusion layer (GDL) 51 facilitates water and oxygen gas transport to and from the anode, respectively, and hydrogen ions (H⁺) and water (carried electro-osmotically through the PEM membrane with the solvated protons) transport from the anode through the membrane to the cathode, conducting electrical current. Also, some of the produced hydrogen gas transports through the membrane from the cathode to the anode by diffusion, resulting in undesired “hydrogen crossover.” GDLs 51 and 52 are both porous and electrically conductive, and on the cathode side are typically composed of carbon fibers. However, in order to avoid degradation of carbon at the high potentials of the anode, it is preferred to use a more corrosion resistant material, such as porous titanium, as the GDL on the anode. The GDL may also be called a fluid transport layer (FTL) or a diffuser/current collector (DCC).

Fuel Cell

Fuel cells offer the opportunity for clean exhaust and enhanced energy conversion resulting from the combining of hydrogen gas and oxygen to form water. The power generated from a hydrogen fuel cell depends on the ohmic resistance of the PEM. To decrease the ohmic resistance, PEMs have become thinner, which can result in durability and/or handling issues. In the present disclosure, it has been discovered that the use of the platinum-coated polyimide particles in the PEM can not only improve the durability of the thinner PEM, but also allow humidifying of the PEM, which also reduces ohmic resistance.

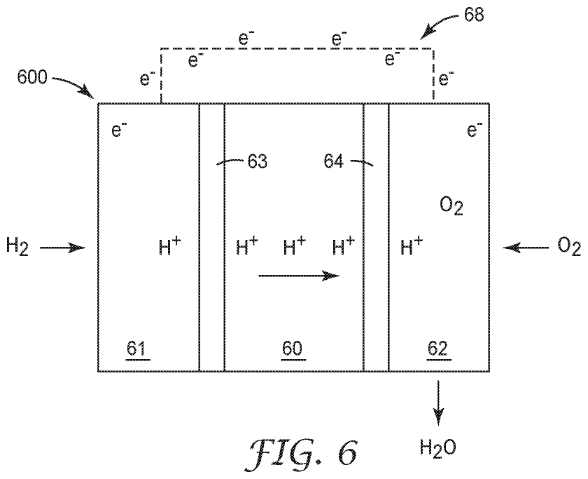

Shown in FIG. 6, is exemplary fuel cell 600 in use with external electrical circuit 68, where fuel cell 600 includes PEM 60 of the present description, anode 63, and cathode 64.

In some embodiments, cathode 64 comprises a first catalyst of metallic Pt and/or Pt oxide. Anode 63 has second catalyst comprising metallic Ir and/or Ir oxide. As shown, cell 600 also includes optional first fluid transport layer (FTL) 61 adjacent anode 63, and optional second fluid transport layer 62 situated adjacent cathode 64. FTLs 61 and 61 may each be any suitable electrically conductive porous substrate, such as carbon fiber constructions (e.g., woven and non-woven carbon fiber constructions). Gas diffusion layers 61 and 62 may also be treated to increase or impart hydrophobic properties.

During operation, hydrogen fuel (H₂) is introduced into gas diffusion layer 61. Alternatively, fuel sources other than hydrogen may be used, such as methanol, ethanol, formic acid, and reformed gases. The fuel passes through gas diffusion layer 61 and over anode 63, where the fuel is separated into hydrogen ions (H⁺) and electrons (e⁻). Electrolyte membrane 60 only permits the hydrogen ions to pass through to reach cathode 64 and gas diffusion layer 62. The electrons cannot pass through electrolyte membrane 60. As such, the electrons flow through external electrical circuit 68 in the form of electric current. This current can power an electric load, such as an electric motor, or be directed to an energy storage device, such as a rechargeable battery. Oxygen (O₂) is introduced into gas diffusion layer 62. The oxygen passes through gas diffusion layer 62 and cathode 64. At cathode 64, oxygen, hydrogen ions, and electrons combine to produce water and heat.

Exemplary embodiments of the present disclosure include, but should not be limited to, the following:

### Embodiment 1

A composition comprising:

a plurality of particles, wherein the particles comprise a polyimide core; and a coating thereon, wherein the coating comprises at least one of a metallic platinum and a platinum oxide.

### Embodiment 2

The composition of embodiment 1 wherein the particles are substantially spherical.

### Embodiment 3

The composition of any one of the previous embodiments, wherein the particles have an average diameter of less than 10 micrometers.

### Embodiment 4

The composition of any one of the previous embodiments, wherein the coating has an average thickness of less than 25 nm.

### Embodiment 5

The composition of any one of the previous embodiments, wherein the coating is not continuous.

### Embodiment 6

The composition of any one of the previous embodiments, wherein the coating comprises discrete regions of platinum having an average diameter of no more than 10 nanometers.

### Embodiment 7

The composition of any one of the previous embodiments, wherein the coating consists essentially of at least one of metallic platinum and platinum oxide.

### Embodiment 8

The composition of any one of the previous embodiments, wherein the coating is disposed directly on the surface of the core.

### Embodiment 9

The composition of any one of the previous embodiments, wherein the plurality of particles comprise at least 0.18 and at most 72% by weight of at least one of metallic platinum or platinum oxide calculated as elemental platinum.

### Embodiment 10

The composition of any one of the previous embodiments, wherein the polyimide comprises at least one of the following monomeric units:

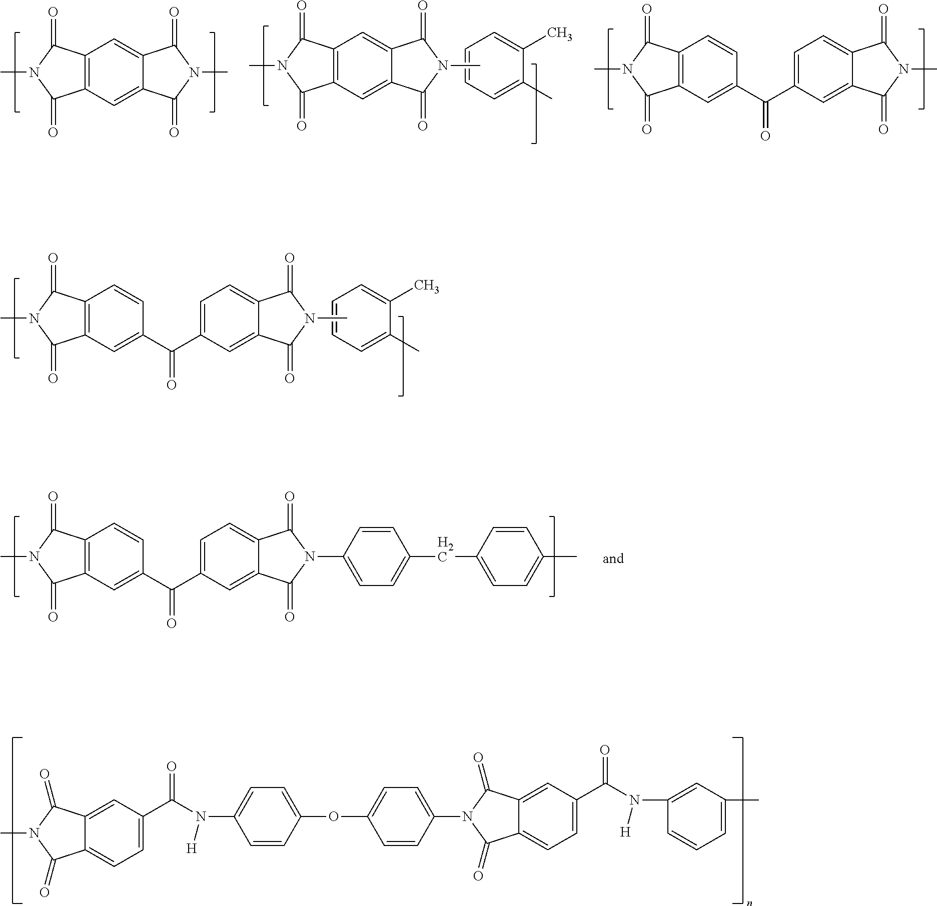

### Embodiment 11

A polymer electrolyte membrane comprising:

the composition of any one of the previous embodiments, wherein the composition is dispersed within an ion-conductive polymer.

### Embodiment 12

The polymer electrolyte membrane of embodiment 11, wherein the composition is homogeneously dispersed within an ion-conductive polymer.

### Embodiment 13

The polymer electrolyte membrane of any one of embodiments 11-12, wherein the ion-conductive polymer comprises a side group of —RfSO₂Y wherein Rf is a branched or non-branched perfluoroalkyl group, perfluoroalkoxy group or perfluoroether group; and Y is —OH, —NHSO₂—R_{f}^{″}, —NHSO₂—R_{f}^{′}—SO₃H, —NHSO₂—R_{f}^{′}—SO₂—NH—SO₂—R, where R_{f}^{″} is a fluorinated alkyl group, R_{f}^{′} is a fluorinated alkylene group, and R is a fluorinated alkyl group or a nonfluorinated alkyl or aryl group.

### Embodiment 14

The polymer electrolyte membrane of embodiment 13, wherein the ion-conductive polymer comprises a side group having the structure selected from the group consisting of:

—OCF₂CF₂SO₂Y, —OCF₂CF₂CF₂CF₂SO₂Y, and —OCF₂CF(CF₃)OCF₂CF₂SO₂Y, wherein Y is —OH, —NHSO₂—R_{f}^{″}, —NHSO₂—R_{f}^{′}—SO₃H, —NHSO₂—R_{f}^{′}—SO₂—NH—SO₂—R, where R_{f}^{″} is a perfluorinated alkyl group, R_{f}^{′} is a perfluorinated alkylene group, and R is a perfluorinated alkyl group, a partially fluorinated alkyl group or a nonfluorinated alkyl or aryl group, which each optionally comprise at least one an ether linkage.

### Embodiment 15

The polymer electrolyte membrane of any one of embodiments 11-13, wherein the polymer electrolyte membrane comprises a weight % of the composition to the ion-conductive polymer of at least 0.05% and no more than 50%.

### Embodiment 16

The polymer electrolyte membrane of any one of embodiments 11-15, wherein the polymer electrolyte membrane is dense and substantially pore-free.

### Embodiment 17

The polymer electrolyte membrane of any one of embodiments 11-16, wherein the polymer electrolyte membrane comprises a mechanical support.

### Embodiment 18

The polymer electrolyte membrane of embodiment 17, wherein the mechanical support comprises at least one of a non-woven material, a woven material, and a perforated sheet.

### Embodiment 19

The polymer electrolyte membrane of any one of embodiments 11-18, wherein the polymer electrolyte membrane further comprises at least one of cerium oxide and manganese oxide.

### Embodiment 20

The polymer electrolyte membrane of any one of embodiments 11-19, wherein the polymer electrolyte membrane thickness is at least 1 micrometer and at most 1000 micrometers.

### Embodiment 21

The polymer electrolyte membrane of any one of embodiments 11-20, wherein a first ion-conductive layer is disposed on a first major surface of the polymer electrolyte membrane.

### Embodiment 22

The polymer electrolyte membrane of any one of embodiments 11-21, wherein a second ion-conductive layer is disposed on a second major surface of the polymer electrolyte membrane, opposite the first major surface of the polymer electrolyte membrane.

### Embodiment 23

The polymer electrolyte membrane of any one of embodiments 21-22, wherein the first ion-conductive layer comprises a plurality of polyimide particles.

### Embodiment 24

The polymer electrolyte membrane of any one of embodiments 22-23, wherein the second ion-conductive layer comprises a plurality of polyimide particles.

### Embodiment 25

A membrane electrode assembly comprising a positive electrode, a negative electrode and the polymer electrolyte membrane of any one of embodiments 11-24 disposed therebetween.

### Embodiment 26

A water electrolyzer comprising the membrane electrode assembly of embodiment 25.

### Embodiment 27

A fuel cell comprising the membrane electrode assembly of embodiment 25.

### Embodiment 28

A method of generating hydrogen and oxygen from water, the method comprising:

providing a water electrolyzer of embodiment 26;
providing water in contact with the electrode; and
providing an electrical potential difference across the membrane with sufficient current to convert at least a portion of the water to hydrogen and oxygen on the cathode and anode, respectively.

### Embodiment 29

A method of generating electricity from hydrogen and oxygen, the method comprising:

providing a fuel cell of embodiment 27;
providing hydrogen in contact with the anode and oxygen in contact with the cathode; and
generating an electrical potential difference across the membrane with sufficient current to convert at least a portion of the hydrogen and oxygen to water.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods.

These abbreviations are used in the following examples: g=grams, min=minutes, ° C.=degrees Celsius, MPa=megapascals, MOhm=mega Ohm, and sccm=standard cubic centimeters per minute.

TABLE 1

| Material Abbreviation | |
|---|---|
| or Trade Designation | Source |
| “NAFION 117” | A polymeric perfluorosulfonic acid (PFSA) cation |
| | exchange membrane, which was 183-micrometers thick |
| | was obtained under the trade designation “NAFION 117” |
| | from DuPont, Wilmington, DE. |
| 3M825EW MEMBRANE | 825 g/mol equivalent weight polymeric perfluorosulfonic |
| | acid proton exchange membrane (PEM), which was 50- |
| | micrometers thick obtained under the trade designation |
| | “3M825EW MEMBRANE” from 3M Company, St. Paul, |
| | MN. |
| 3M825EW SOLUTION | 825 g/mol equivalent weight polymeric perfluorosulfonic |
| | acid ion exchange resin dispersion (34 wt. % in a 75:25 mix |
| | of ethanol and water), obtained under the trade designation |
| | “3M825EW SOLUTION” from 3M Company. |
| PR 149 | Perylene red pigment (i.e., N,N′-di(3,5-xylyl)perylene- |
| | 3,4:9,10-bis(dicarboximide)), obtained under the trade |
| | designation “C.I. PIGMENT RED 149,” also known as |
| | “PR 149,” from Clariant, Charlotte, NC. |
| Ir-NSTF | 0.5 mg/cm² iridium/iridium oxide nanostructured thin film |
| | (NSTF) prepared as described below. |
| Pt-NSTF | 0.25 mg/cm² nanostructured thin film (NSTF) catalyst |
| | supported on perylene red whiskers, prepared as described |
| | below. |
| Dimethyl(1,5-cyclooctadiene) platinum | (CH₃)₂C₈H₁₂Pt, Gelest Inc., Morrisville, PA. |
| (II) | |
| Polyimide Powder | Polyimide powder, obtained under the trade designation |
| | “POLYIMDE P84 NT1” from Evonik Fibres GmbH, |
| | Gewerbepark 4, 4861 Schörfling am Attersee, Austria |
| | having a particle size of 1-10 micrometers. |
| KAPTON | Polyimide film, 2 mil (51 micrometer) thick, obtained |
| | under the trade designation “KAPTON” from DuPont, |
| | Wilmington, DE. |

Preparation of Platinum-Coated Polyimide Particles (Pt/PI):

Pt-coated polyimide powder particles were prepared though chemical vapor deposition (CVD) at 200° C. using dimethyl(1,5-cyclooctadiene) platinum (II) as a Pt precursor. First, the Polyimide Powder were placed in a tubular furnace with controlled atmosphere. This tubular furnace held a 6 inch (15 cm) diameter quartz tube, which was connected to a scroll pump equipped with a chemical filter. Argon and hydrogen gas were used as a carrier and reactive gas, respectively. 0.5 g of dimethyl(1,5-cyclooctadiene) platinum (II) was placed in the quartz tube, but outside the tubular furnace. The pressure inside the quartz tube was then reduced to a millitorr (mTorr) range. The temperature of the furnace was increased from room temperature to 200° C. A mixture of hydrogen (2 sccm) and argon (40 sccm) was introduced into the vacuum quartz tube. A pressure of 5 Torr was maintained using a pressure control butterfly valve. The Pt source was vaporized around 50° C. using a separate heater wrapped around the quartz tube allowing a uniform deposition on the surface of the polyimide powder until the Pt source was evaporated completely.

Preparation of Nanostructured Thin Film (NSTF) Catalysts on Perylene Red Whiskers:

Preparing Web of Supported Microstructured Whiskers

Microstructured whiskers were prepared by thermally annealing a layer of PR 149 that was sublimation vacuum coated onto microstructured catalyst transfer polymer substrates (MCTS) with a nominal thickness of 220 nm, as described in detail in U.S. Pat. No. 4,812,352 (Debe), the disclosure of which is incorporated herein by reference.

A roll-good web of the MCTS (made on KAPTON) was used as the substrate on which the PR149 was deposited, as described in detail in U.S. Pat. No. 6,136,412 (Spiewak et al.) the disclosure of which is incorporated herein by reference. The MCTS substrate surface had V-shaped features with about 3 micrometer tall peaks, spaced 6 micrometers apart. A nominally 100 nm thick layer of Cr was then sputter deposited onto the MCTS surface using a DC magnetron planar sputtering target and typical background pressures of Ar and target powers known to those skilled in the art sufficient to deposit the Cr in a single pass of the MCTS web under the target at the desired web speed.

The Cr-coated MCTS web then continued over a sublimation source containing the PR 149. The PR 149 was heated to a controlled temperature near 500° C. to generate sufficient vapor pressure flux to deposit 0.022 mg/cm², or an approximately 220 nm thick layer of the PR 149 in a single pass of the web over the sublimation source. The mass or thickness deposition rate of the sublimation can be measured in any suitable fashion known to those skilled in the art, including optical methods sensitive to film thickness, or quartz crystal oscillator devices sensitive to mass. The PR 149 coating was then converted to the whisker phase by thermal annealing, as described in detail in U.S. Pat. No. 5,039,561 (Debe) the disclosure of which is incorporated herein by reference, by passing the PR 149-coated web through a vacuum having a temperature distribution sufficient to convert the PR 149 as-deposited layer into a layer of oriented crystalline whiskers at the desired web speed, such that the whisker layer has an average whisker areal number density of about 68 whiskers per square micrometer, determined from scanning electron microscopy (SEM) images, with an average length of about 0.6 micrometer.

Pt-NSTF and Ir-NSTF: Preparing catalyst coated nanostructured thin films on supported microstructured whiskers.

A catalyst coated nanostructured thin film (NSTF) was prepared by sputter coating the catalyst onto the web of supported microstructured whiskers from above using a vacuum sputter deposition system similar to that described in FIG. 4A of U.S. Pat. No. 5,879,827 (Debe et al.), but equipped with additional capability to allow coatings on roll-good substrate webs. The coatings were sputter deposited by using ultra high purity Ar as the sputtering gas at approximately 5 mTorr pressure. Catalyst layers were deposited onto the web of supported nanostructured whiskers by exposing the roll-good substrate in sections to an energized 5 inch×15 inch (13 cm×38 cm) planar sputtering target (i.e., an Ir metal for the Ir-NSTF and a Pt metal for the PT-NSTF), resulting in the deposition of the catalyst onto the surface of the entire roll-good substrate. The magnetron sputtering target deposition rate and web speed were controlled to give the desired areal loading of catalyst on the substrate. The DC magnetron sputtering target deposition rate and web speed were measured by standard methods known to those skilled in the art. The substrate was repeatedly exposed to the energized sputtering target, resulting in additional deposition of catalyst onto the substrate, until the desired areal loading was obtained. This method was used to produce whisker-supported catalysts Ir-NSTF (0.5 mg/cm² iridium/iridium oxide nanostructured thin film (NSTF) catalyst supported on PR 149 whiskers,), and Pt-NSTF (0.25 mg/cm² platinum/platinum oxide nanostructured thin film (NSTF) catalyst supported on PR 149 whiskers).

Preparation of Catalyst-Coated Membranes (CCMs):

A catalyst-coated membrane (CCM) was made by transferring the Pt-NSTF or Ir-NSTF described above onto both surfaces of each of the PEMs described below. A Pt-NSTF catalyst layer was laminated to one side (intended to become the cathode side) of the PEM, and an Ir-NSTF catalyst layer was laminated to the other (anode) side of the PEM. The catalyst transfer was accomplished by hot roll lamination of the NSTF catalysts onto the PEM: the hot roll temperatures were 350° F. (177° C.) and the gas line pressure fed to force laminator rolls together at the nip ranged from 150 psi to 180 psi (1.03 MPa to 1.24 MPa). The catalyst coated Microstructured Catalyst Transfer Substrates (MCTSs) were precut into 13.5 cm×13.5 cm square shapes and sandwiched onto (one or) both side(s) of a larger square of PEM. The PEM with catalyst coated MCTS on one or both side(s), was placed between KAPTON and then paper was placed on the outsides of the sandwiched structure prior to passing the stacked assembly through the nip of the hot roll laminator at a speed of 1.2 ft/min (37 cm/min). Immediately after passing through the nip, while the assembly was still warm, the layers of KAPTON and paper were quickly removed and the Cr-coated MCTS substrates were peeled off the CCM by hand, leaving the catalyst coated whiskers stuck to the PEM surface(s).

CCM Test:

The catalyst coated membranes (CCM) as described below were tested in an H₂/O₂ electrolyzer single cell. The CCMs were installed with appropriate gas diffusion layers directly into a 50 cm² single fuel cell test station (obtained under the trade designation “50SCH” from Fuel Cell Technologies, Albuquerque, N. Mex.), with quad serpentine flow fields. The normal graphite flow field block on the anode side was replaced with a Pt plated Ti flow field block of the same dimensions and flow field design (obtained from Giner, Inc., Auburndale, Mass.) in order to withstand the high anode potentials during electrolyzer operation. Purified water with a resistivity of 18 MOhms was supplied to the anode at 75 mL/min. A potentiostat (obtained under the trade designation “VMP-3,” Model VMP-3 from Bio-Logic Science Instruments SAS, Seyssinet-Pariset, France) coupled with a 100 A/5 V booster (obtained under the trade designation “VMP-300,” from Bio-Logic Science Instruments SAS, Seyssinet-Pariset, France) was connected to the cell and was used to control the applied cell voltage or current density.

The anode output was connected to a gas chromatograph (obtained under the trade designation “MICRO490”, Model 490 Micro GC from Agilent, Santa Clara, Calif.) for analysis of the output gas hydrogen content. All tests were carried out at a temperature of 80° C. with DI water (18 Mohm cm) flowing at a rate of 75 mL/min to the anode. Under ambient pressure condition (i.e., 1 bar at the cathode compartment and 1 bar at the anode compartment), the level of H₂ crossover through each membrane to the anode was measured by measuring the mole percent of H₂ in O₂ at 80° C., varying current densities ranging from 2.0 to 0.05 A/cm².

Preparation of CCMs

### Comparative Example A

The CCM was prepared by hot roll laminating NAFION 117 between Pt-NSTF and Ir-NSTF.

### Comparative Example B

A CCM was prepared as in Comparative Example A, except NAFION 117 was replaced by two 3M825EW MEMBRANEs. The two membranes were combined into a single membrane through hot roll lamination (laminator temperature, 350° F. (177° C.); applied pressure, 150 psi (1 MPa); and roller speed: 0.5 ft/min (15 cm/min) before lamination with the Pt-NSTF and Ir-NSTF.

### Comparative Example C

A membrane was prepared as follows: 0.068 grams of a Polyimide Powder, 2 grams deionized (DI) water, and 20 grams 3M825EW SOLUTION were mixed together and the composite mixture slowly stirred at 100 revolutions per minute (rpm) to obtain a homogeneous mixture. The resulting mixture was then immediately used to cast a membrane. To prepare the 100 micrometer thick composite membrane layer, a 5 inch (12.7 cm) wide microfilm applicator (Paul N. Gardner Company, Inc., wet film thickness: 30 mils (0.72 millimeter)) was used to coat KAPTON with the composite mixture. The coated sample was dried at 70° C. for 15 minutes and then at 120° C. for 30 minutes followed by annealing at 160° C. for 10 minutes. The annealed sample was then cooled down to room temperature and the KAPTON was peeled off by hand to form a membrane composed of 1 wt % of polyimide powder in perfluorosulfonic acid ionomer.

A CCM was prepared as in Comparative Example A except that the 3M825EW MEMBRANE was replaced with a membrane as described above.

### Comparative Example D

A membrane was prepared as follows: 0.260 grams of Polyimide Powder, 2 grams deionized (DI) water, and 20 grams of 3M825EW SOLUTION were mixed together and the composite mixture slowly stirred at 100 rpm to obtain a homogeneous mixture. The resulting mixture was then cast, annealed, and removed from KAPTON as described in Comparative Example C to form a membrane composed of 3 wt % of polyimide powder in perfluorosulfonic acid ionomer.

A CCM was prepared as in Comparative Example A, except that the membrane was replaced with the membrane just described.

### Example 1

A membrane was prepared as follows: 0.0034 grams of Pt/PI (described above) and 20 grams 3M825EW SOLUTION were mixed together and the composite mixture slowly stirred at 100 rpm to obtain a homogeneous mixture. The resulting mixture was then cast, annealed, and removed from KAPTON as described in Comparative Example C to form a membrane composed of 0.05 wt % of platinum-coated polyimide particles in perfluorosulfonic acid ionomer.

A CCM was prepared as described in Comparative Example A except that the membrane was replaced with the membrane just described.

### Example 2

A membrane was prepared as follows: 0.0342 grams of Pt/PI (described above) and 20 grams 3M825EW SOLUTION were mixed together and the composite mixture slowly stirred at 100 rpm to obtain a homogeneous mixture. The resulting mixture was then cast, annealed, and removed from the KAPTON as described in Comparative Example C to form a membrane composed of 0.5 wt % of platinum-coated polyimide particles and perfluorosulfonic acid (PFSA) ionomer.

A CCM was prepared as described in Comparative Example A, except that the membrane was replaced with the membrane just described.

### Example 3

A CCM was prepared from two ion-conducting polymer layers, in which the membrane forming the layer containing 1 wt % of Pt/PI was laminated to 3M825EW MEMBRANE.

To prepare the 1 wt % of Pt/PI/PFSA 825EW composite membrane layer, 0.0687 grams of a Pt/PI, 1 gram of deionized (DI) water, and the 20 grams of 3M825EW SOLUTION were mixed together and the composite mixture slowly stirred at 100 rpm to obtain a homogeneous mixture. The resulting mixture (i.e., composite formulation) was then immediately used to cast a membrane. A 5 inch (12.7 cm) wide microfilm applicator (wet film thickness: 15 mils (0.38 millimeter) Paul N. Gardner Company, Inc.) was used to coat KAPTON with the composite mixture. The coated sample was dried at 70° C. for 15 minutes and then at 120° C. for 30 minutes, followed by annealing at 160° C. for 10 minutes. The annealed sample was then cooled down to room temperature, resulting in a thickness of about 50 micrometers.

To prepare a two-layer membrane, the resulting annealed membrane was laminated with a 3M825EW MEMBRANE through hot roll lamination (laminator temperature, 350° F. (177° C.); applied pressure, 150 psi (1 MPa); and roller speed, 0.5 feet per minute (2.54 mm per second).

To prepare the CCM, the major surface of the two-layer membrane containing the Pt/PI was laminated to the iridium anode catalyst that comprised Ir-NSTF, while the opposing major surface of the two-layer membrane (i.e., the 3M825EW MEMBRANE layer) was laminated to the platinum cathode catalyst that comprised Pt-NSTF.

### Example 4

A CCM was prepared as described in Example 3, except that the major surface of the two-layer membrane containing the Pt/PI was laminated to the platinum cathode catalyst that comprised Pt-NSTF, while the opposing major surface of the two-layer membrane (i.e., the 3M825EW MEMBRANE layer) was laminated to the iridium anode catalyst that comprised Ir-NSTF.

### Example 5

A CCM was prepared as described in Example 3, except that in the two-layer construction, the layer containing Pt/PI had a loading of Pt/PI of 3 wt %.

To prepare the 3 wt % of Pt/PI composite membrane layer, 0.2103 grams of Pt/PI, 1 gram of deionized (DI) water, and 20 grams of 3M825EW SOLUTION were used.

### Example 6

A CCM was prepared as described in Example 5, except that the major surface of the two-layer membrane containing the Pt/PI was laminated to the platinum cathode catalyst that comprised Pt-NSTF, while the opposing major surface of the two-layer membrane (i.e., the 3M825EW MEMBRANE layer) was laminated to the iridium anode catalyst that comprised Ir-NSTF.

The resulting CCMs described above were installed in a small single cell water electrolyzer and tested for hydrogen crossover through the membrane from the hydrogen-producing cathode to the oxygen-generating anode compartment, by analyzing the effluent of the anode compartment with a gas chromatograph adapted to detect hydrogen gas. The test is further described above under the CCM Test.

For efficiency, it is often desired to operate electrolyzer cells at a hydrogen side pressure of 30 bar while staying far below the explosion limit of 4 mol % H₂ in O₂. The average values of the mole percent of H₂ measured at 0.1 A/cm² over one hour are listed in Table 2, below.

TABLE 2
CCM Examples

| | Approximate | H2 Crossover | |
|---|---|---|---|
| | Membrane | mol % H₂ in O₂ | |
| | Thickness | at 1 bar | at 30 bar |
| | (μm) | (0.1 MPa) | (3 MPa) |
| Comparative Example A | 183 | 0.52 | 1.79 |
| Comparative Example B | 100 | 0.81 | >2.00 |
| Comparative Example C | 100 | 0.89 | NM |
| Comparative Example D | 100 | 0.59 | NM |
| Example 1 | 100 | 0.17 | NM |
| Example 2 | 100 | 0.050 | NM |
| Example 3 | 100 | 0.025 | NM |
| Example 4 | 100 | 0.009 | NM |
| Example 5 | 100 | 0.008 | NM |
| Example 6 | 100 | 0.005 | NM |

Where NM means not measured

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A composition comprising:
a plurality of particles, wherein the particles comprise a polyimide core; and a coating thereon, wherein the coating comprises at least one of a metallic platinum and a platinum oxide.

2. The composition of claim 1 wherein the particles are substantially spherical.

3. The composition of claim 1, wherein the particles have an average diameter of less than 10 micrometers.

4. The composition of claim 1, wherein the coating has an average thickness of less than 25 nm.

5. The composition of claim 1, wherein the coating is not continuous.

6. The composition of claim 1, wherein the coating comprises discrete regions of platinum having an average diameter of no more than 10 nanometers.

7. The composition of claim 1, wherein the plurality of particles comprise at least 0.18 and at most 72% by weight of at least one of metallic platinum or platinum oxide calculated as elemental platinum.

8. The composition of claim 1, wherein the polyimide comprises at least one of the following monomeric units:

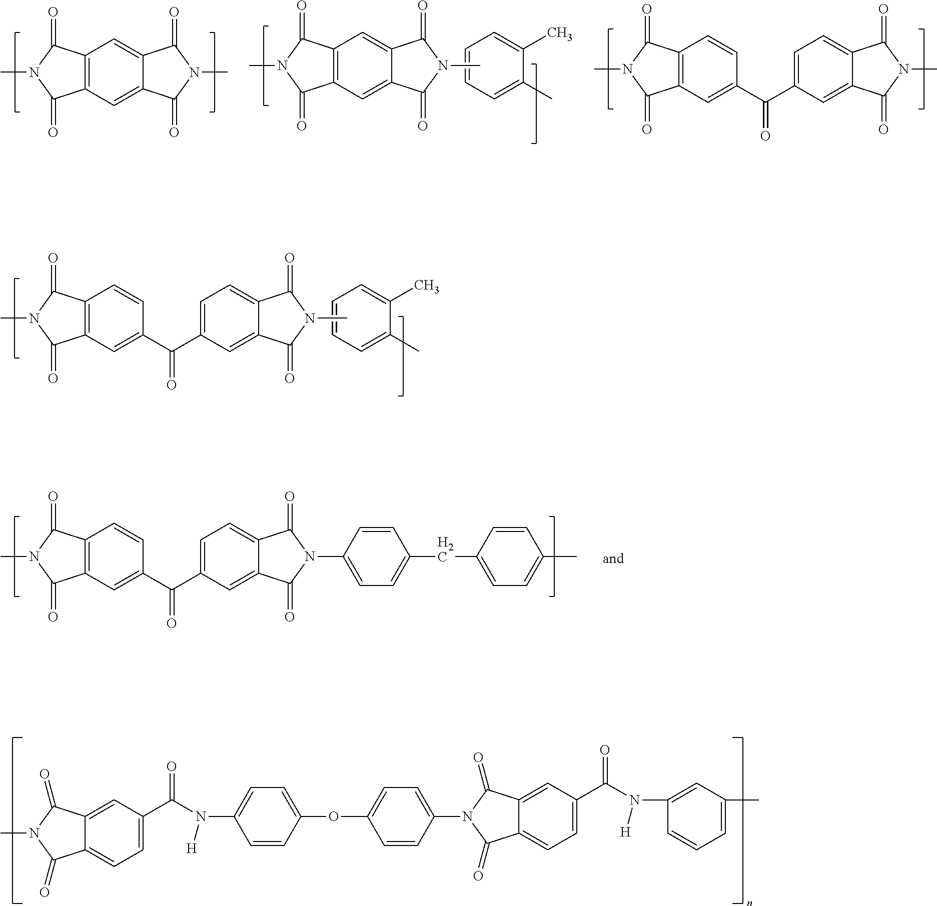

9. A polymer electrolyte membrane comprising:
the composition of claim 1, wherein the composition is dispersed within an ion-conductive polymer.

10. The polymer electrolyte membrane of claim 9, wherein a first ion-conductive layer is disposed on a first major surface of the polymer electrolyte membrane and optionally, wherein the first ion-conductive layer comprises a plurality of polyimide particles.

11. A membrane electrode assembly comprising a positive electrode, a negative electrode and the polymer electrolyte membrane of claim 9 disposed therebetween.

12. A water electrolyzer comprising the membrane electrode assembly of claim 11.

13. A fuel cell comprising the membrane electrode assembly of claim 11.

14. A method of generating hydrogen and oxygen from water, the method comprising:
providing a water electrolyzer of claim 12;
providing water in contact with the electrode; and
providing an electrical potential difference across the membrane with sufficient current to convert at least a portion of the water to hydrogen and oxygen on the cathode and anode, respectively.

15. A method of generating electricity from hydrogen and oxygen, the method comprising:
providing a fuel cell of claim 13;
providing hydrogen in contact with the anode and oxygen in contact with the cathode; and
generating an electrical potential difference across the membrane with sufficient current to convert at least a portion of the hydrogen and oxygen to water.

16. The composition of claim 1, wherein the coating consists essentially of at least one of metallic platinum and platinum oxide.

17. The composition of claim 1, wherein the coating is disposed directly on the surface of the core.

18. The polymer electrolyte membrane of claim 9, wherein the ion-conductive polymer comprises a side group of —RfSO₂Y wherein Rf is a branched or non-branched perfluoroalkyl group, perfluoroalkoxy group or perfluoroether group; and Y is —OH, —NHSO₂—R_{f}^{″}, —NHSO₂—R_{f}^{′}—SO₃H, —NHSO₂—R_{f}^{′}—SO₂—NH—SO₂—R, where R_{f}^{″} is a fluorinated alkyl group, R_{f}^{′} is a fluorinated alkylene group, and R is a fluorinated alkyl group or a nonfluorinated alkyl or aryl group.

19. The polymer electrolyte membrane of claim 9, wherein the polymer electrolyte membrane comprises a weight % of the composition to the ion-conductive polymer of at least 0.05% and no more than 50%.
